(19) United States
(12) Patent Application Publication
(10) Pub. No.: US 2026/0167048 A1
(43) Pub. Date: Jun. 18, 2026

(54) APPARATUS AND METHOD OF MANAGING ELECTRIC VEHICLE CHARGING IN CHARGING STATION

(71) Applicants: HYUNDAI MOTOR COMPANY, SEOUL (KR); KIA CORPORATION, SEOUL (KR)

(72) Inventors: Jungmo Yu, Hwaseong-si (KR); Jeawan Kim, Hwaseong-si (KR)

(73) Assignees: HYUNDAI MOTOR COMPANY, SEOUL (KR); KIA CORPORATION, SEOUL (KR)

(21) Appl. No.: 19/278,092

(22) Filed: Jul. 23, 2025

(30) Foreign Application Priority Data
Dec. 13, 2024 (KR) 10-2024-0185597

(51) Int. Cl. B60L 53/67

(52) U.S. Cl. CPC B60L 53/67; B60L 2240/80; B60L 2250/10; B60L 2260/58

(57) ABSTRACT

A method of managing electric vehicle charging in a charging station includes receiving charger information and vehicle charging status information for a plurality of chargers from a charging station, determining and providing a time remaining until completion of charging of a first vehicle to a first charging person, who is an owner of the first vehicle which is being charged, connected to a first charger among the plurality of chargers, requesting a second charging person, who is an owner of a second vehicle of which charging has been completed, connected to a second charger among the plurality of chargers, to pick up the second vehicle, and determining and providing a time remaining until the completion of charging of the first vehicle and a time elapsed after the completion of the charging of the second vehicle to a charging waiting person to use the charging station.

### CROSS REFERENCE TO RELATED APPLICATIONS

This application claims priority to and the benefit of Korean Patent Application No. 10-2024-0185597 filed with the Korean Intellectual Property Office on December 13, 2024, the entire contents of which are incorporated herein by reference.

### BACKGROUND

### (a) Field

The present disclosure relates to an apparatus and method of managing charging of an electric vehicle in a charging station, and more particularly, to an apparatus and method of managing charging of an electric vehicle in a charging station that eliminate inconvenience of congestion and long waiting times in a charging station for an electric vehicle.

### (b) Description of the Related Art

There are some inconveniences of electric vehicle charging parking areas. First, there are many cases where it is necessary to wait for a long time due to insufficient charging areas. Second, ordinary vehicles illegally park in electric vehicle charging areas, causing inconvenience to electric vehicle drivers. Third, the use of chargers is often limited due to some charger failures or lack of management. Fourth, due to a long charging time, it occupies a parking space for a long time, resulting in an unnecessary waiting situation. Finally, most of the charging areas are far from the parking lot, so accessibility is often poor.

### SUMMARY

The present disclosure attempts to provide an apparatus and method of managing electric vehicle charging in a charging station that manage electric vehicle charging by providing charger information for a plurality of chargers in the charging station to charging people and people waiting for charging.

An embodiment of the present disclosure provides a method of managing electric vehicle charging in a charging station, the method including receiving charger information and vehicle charging status information for a plurality of chargers from a charging station; determining and providing a time remaining until completion of charging of a first vehicle to a first charging person, who is an owner of the first vehicle, which is being charged, connected to a first charger among the plurality of chargers; requesting a second charging person, who is an owner of a second vehicle, of which charging has been completed, connected to a second charger among the plurality of chargers, to pick up the second vehicle; and determining and providing a time remaining until the completion of charging of the first vehicle and a time elapsed after the completion of the charging of the second vehicle to a charging waiting person to use the charging station.

The receiving of the charger information and the vehicle charging status information for the plurality of chargers from the charging station may include directly receiving charger information and vehicle charging status information for the plurality of chargers from the plurality of chargers through a charger management server.

The receiving of the charger information and the vehicle charging status information for the plurality of chargers from the charging station may include receiving the charger information and the vehicle charging status information from a vehicle connected to the charger.

The method may further include determining a shortest distance between the first vehicle and the first charging person based on a GPS of a charging person terminal of the first charging person; and providing an alarm to the first charging person when the shortest distance exceeds a preset reference distance.

The method may further include determining a walking movement time of the first charging person to the first vehicle based on the shortest distance; and providing an alarm to the first charging person when the time remaining until the completion of the charging is less than the walking movement time.

The method may further include providing an interface for requesting the second charging person to pick up the second vehicle to a charging waiting person terminal of the charging waiting person when the time elapsed after the completion of charging of the second vehicle exceeds a preset reference time.

The method may further include when the second vehicle is disconnected from the second charger after the request to pick up the second vehicle is received through the interface of the charging waiting person terminal, providing a notification to the charging waiting person about the disconnection of the second vehicle.

The method may further include when the second charging person receives a request for pickup of the second vehicle and picks up the second vehicle within a predetermined time, and when the charging waiting person uses the second charger, providing a reward to the second charging person through a charging person terminal.

Another embodiment of the present disclosure provides an apparatus for managing electric vehicle charging in a charging station by executing a program code loaded in one or more memory devices through one or more processors and providing charger information about a plurality of chargers in a charging station to a charging person and a charging waiting person, in which the program code is executed to receive the charger information and the vehicle charging status information for the plurality of chargers from the charging station, determine and provide a time remaining until completion of charging of a first vehicle to a first charging person, who is an owner of the first vehicle, which is being charged, connected to a first charger among the plurality of chargers, request a second charging person, who is an owner of a second vehicle, of which charging has been completed, connected to a second charger among the plurality of chargers, to pick up the second vehicle, and determine and provide a time remaining until the completion of charging of the first vehicle and a time elapsed after the completion of the charging of the second vehicle to a charging waiting person to use the charging station.

The receiving of the charger information and the vehicle charging status information for the plurality of chargers from the charging station may include directly receiving charger information and vehicle charging status information for the plurality of chargers from the plurality of chargers through a charger management server.

The receiving of the charger information and the vehicle charging status information for the plurality of chargers from the charging station may include receiving the charger information and the vehicle charging status information from a vehicle connected to the charger.

The processor may be executed to further determine a shortest distance between the first vehicle and the first charging person based on a GPS of a charging person terminal of the first charging person, and provide an alarm to the first charging person when the shortest distance exceeds a preset reference distance.

The processor may be executed to further determine a walking movement time of the first charging person to the first vehicle based on the shortest distance, and provide an alarm to the first charging person when the time remaining until the completion of the charging is less than the walking movement time.

The processor may be executed to provide an interface for requesting the second charging person to pick up the second vehicle to a charging waiting person terminal of the charging waiting person when the time elapsed after the completion of charging of the second vehicle exceeds a preset reference time.

The processor may be executed to further, when the second vehicle is disconnected from the second charger after the request to pick up the second vehicle is received through the interface of the charging waiting person terminal, provide a notification to the charging waiting person about the disconnection of the second vehicle.

The processor may be executed to further, when the second charging person receives a request for pickup of the second vehicle and picks up the second vehicle within a predetermined time, and when the charging waiting person uses the second charger, provide a reward to the second charging person through a charging person terminal.

The apparatus and method of managing electric vehicle charging in the charging station according to the embodiments of the present disclosure provide charging information for a plurality of chargers in the charging station to a charging person and a charging waiting person, thereby increasing a rotation rate of the electric vehicle charging station and improving the inconvenience caused by waiting for the charging station.

### BRIEF DESCRIPTION OF THE FIGURES

FIG. 1 is a diagram schematically illustrating a system for managing electric vehicle charging in a charging station according to an embodiment of the present disclosure.

FIG. 2 is a block diagram illustrating the system of FIG. 1 in detail according to the embodiment of the present disclosure.

FIG. 3 is a flowchart of a method of managing electric vehicle charging in a charging station according to an embodiment of the present disclosure.

FIGS. 4 and 5 are flowcharts of the method of managing electric vehicle charging in the charging station according to the embodiment of the present disclosure.

FIGS. 6 and 7 are diagrams illustrating a scenario according to the method for managing electric vehicle charging in the charging station according to the embodiment of the present disclosure.

FIG. 8 is a diagram illustrating a computing device according to an embodiment of the present disclosure.

### DETAILED DESCRIPTION

Hereinafter, the present disclosure will be described more fully hereinafter with reference to the accompanying drawings, in which embodiments of the disclosure are shown. As those skilled in the art would realize, the described embodiments may be modified in various different ways, all without departing from the spirit or scope of the present disclosure. Accordingly, the drawings and description are to be regarded as illustrative in nature and not restrictive. Like reference numerals designate like elements throughout the specification.

Throughout the specification and the claims, unless explicitly described to the contrary, the word “comprise”, and variations such as “comprises” or “comprising”, will be understood to imply the inclusion of stated elements but not the exclusion of any other elements. Terms including an ordinary number, such as first and second, are used for describing various constituent elements, but the constituent elements are not limited by the terms. The terms are used only to discriminate one constituent element from another constituent element.

In addition, the terms “… part”, “… unit”, and “… module” described in the specification mean units for processing at least one function and operation and may be implemented by hardware, circuit, or software, or combinations thereof.

Hereinafter, embodiments of the present disclosure will be described in detail with reference to the accompanying drawings.

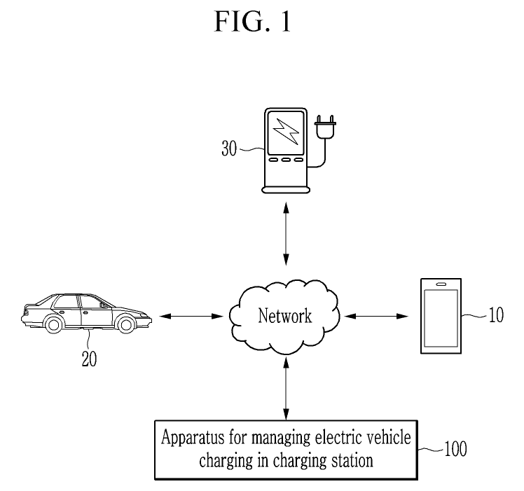

FIG. 1 is a diagram schematically illustrating a system for managing electric vehicle charging in a charging station according to an embodiment of the present disclosure.

Referring to FIG. 1, a system for managing electric vehicle charging in a charging station may include a user terminal 10, a charged vehicle 20, a charger 30, and an apparatus 100 for managing electric vehicle charging in a charging station.

The user terminal 10, the charged vehicle 20, the charger 30, and the apparatus 100 for managing electric vehicle charging in the charging station may be connected to each other through a wired/wireless network.

The user terminal 10 refers to an information processing apparatus or device directly used by a user, and may include various types of computers, smartphones, tablets, and smart watches that may be owned and operated by individuals. The user terminal 10 is mainly connected to a network to transmit and receive data, and is used to execute an application program or search for and communicate information.

The user terminal 10 includes a charging person terminal and a charging waiting person terminal.

In the present specification, a charging person means an owner of a charged vehicle. A charging waiting person means a user or a driver waiting to use a charger used by a charged vehicle.

The charging person terminal may refer to a user terminal owned by a charging person, and the charging waiting person terminal may refer to a user terminal owned by a charging waiting person.

The user terminal 10 may display charger information, vehicle charging state information, a time remaining until charging is completed, and a time elapsed after completion received from the charged vehicle 20, the charger 30, and the apparatus 100 for managing electric vehicle charging in the charging station, to the user through the display.

The charger information may include various information including management number information specifying the charger, specification information of the charger, management number information specifying a charging station where the charger is disposed, and specification information of the charging station.

The vehicle charging state information may include charging start information, charging completion information, and charging progress information, including the battery SoC of the vehicle.

That is, the charging person may receive an alarm for completion of charging, generated from the apparatus 100 for managing electric vehicle charging in the charging station, through the charging person terminal. The charger may check charging state information of the charged vehicle displayed on the charging person terminal. The charging person may check specification information about a charger that is charging the vehicle displayed on the charging person terminal.

The charging waiting person may check charging occupancy status information of chargers in the charging station displayed on the charging waiting person terminal, information on a time remaining until charging is completed, and information on time elapsed after charging is completed.

The charging waiting person may transmit a message requesting pickup of the vehicle to the charging person of the vehicle, which has been completely charged, using the charging waiting person terminal.

The charging waiting person may reserve a charger to be used through the charging waiting person terminal. The charging waiting person may check whether the reserved charger displayed on the charging waiting person terminal is usable.

The charged vehicle 20 may be an electric vehicle or a hybrid vehicle connected to the charger 30. The charged vehicle 20 is wiredly connected to the charger 30 through a charging terminal.

The charged vehicle 20 transmits and receives information to and from the charger 30. The charged vehicle 20 provides the battery SoC of the charged vehicle 20 to the charger 30. The charger 30 may provide the charged vehicle 20 with the charger information and the vehicle charging state information.

The charger 30 may calculate a time remaining until the charging is completed through the battery SoC of the charged vehicle 20. The charger 30 may display a time remaining until the charging is completed. When the charging of the charged vehicle 20 is completed, the charger 30 may calculate time elapsed after the charging is completed.

The charger 30 may have charger information and vehicle charging state information. The charger information may include a management number specifying a charging station and a corresponding charger in the charging station. The charger 30 may be connected to a charger management server. The charger 30 may update charger information and vehicle charging state information to the charger management server.

All chargers 30 in the charging station may provide charger information and vehicle charging state information to the apparatus 100 for managing electric vehicle charging in the charging station through the charger management server.

The apparatus 100 for managing electric vehicle charging in the charging station may receive charger information and vehicle charging state information for chargers in the charging station from the charger 30 through the charger management server.

The apparatus 100 for managing electric vehicle charging in the charging station may provide charger information for a plurality of chargers in the charging station to the charging person and the charging waiting person.

The apparatus 100 for managing electric vehicle charging in the charging station may provide information on a connection state or a disconnection state of the charged vehicle 20 for the charger 30 being charged in the charger 30 to the charging person and the charging waiting person.

The apparatus 100 for managing electric vehicle charging in the charging station may provide an interface to a user through an application of the user terminal 10.

In the embodiment, the apparatus 100 for managing electric vehicle charging in the charging station may receive charger information and vehicle charging state information for a plurality of chargers from the charging station.

The apparatus 100 for managing electric vehicle charging in the charging station may receive charger information and vehicle charging state information for a plurality of chargers from a charger management server that manages chargers in the charging station.

Alternatively, the apparatus 100 in the charging station may be individually connected to each of the chargers through a network to receive charger information and vehicle charging status information of the connected vehicle directly from the individual chargers.

Alternatively, the apparatus 100 in the charging station may receive charger information for the corresponding charger and vehicle charging state information for the corresponding vehicle from a vehicle connected to the charger.

The apparatus 100 for managing electric vehicle charging in the charging station may determine and provide a time remaining until the charging of a first vehicle is completed to a first charging person who is the owner of the first vehicle, which is being charged, connected to a first charger among the plurality of chargers.

The apparatus 100 for managing electric vehicle charging in the charging station may request a second charging person, who is the owner of a second vehicle, of which charging has been completed, connected to a second charger among the plurality of chargers, to pick up the second vehicle.

The apparatus 100 for managing electric vehicle charging in the charging station may determine and provide a time remaining until the charging of the first vehicle is completed and a time elapsed after the charging of the second vehicle is completed to a charging waiting person to use the charging station.

The apparatus 100 for managing electric vehicle charging in the charging station may determine the shortest distance between the first vehicle being charged and the first charging person based on the global positioning system (GPS) of the charging person terminal of the first charging person.

The apparatus 100 for managing electric vehicle charging in the charging station may provide an alarm to the first charging person when the shortest distance exceeds a preset reference distance.

The apparatus 100 for managing electric vehicle charging in the charging station may determine the walking time to the first vehicle of the first charging person based on the shortest distance.

The apparatus 100 for managing electric vehicle charging in the charging station may provide an alarm to the first charging person when a time remaining until charging is completed is less than the walking time.

The apparatus 100 for managing electric vehicle charging in the charging station may provide an interface for requesting the second charging person to pick up the second vehicle to the charging waiting person terminal of the charging waiting person when the time elapsed after the completion of the charging of the second vehicle for which the charging has been completed exceeds a preset reference time.

When the second vehicle is disconnected from the second charger after the pickup request for the second vehicle is received from the charging waiting person terminal, the apparatus 100 for managing electric vehicle charging in the charging station may provide a notification of disconnection of the second vehicle to the charging waiting person.

The apparatus 100 for managing electric vehicle charging in the charging station may provide a reward to the second charging person through the charging person terminal when the second charging person receives a request for pickup of the second vehicle and picks up the second vehicle within a predetermined time.

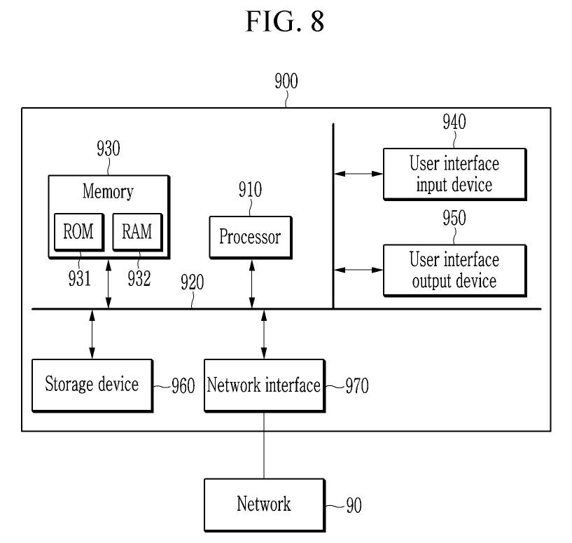

The apparatus 100 for managing electric vehicle charging in the charging station according to the embodiment may execute a program code or instruction stored in one or more memory devices through one or more processors. For example, the apparatus 100 for managing electric vehicle charging in the charging station may be implemented as a computing device 900 as described later with reference to FIG. 8.

In this case, one or more processors may correspond to the processor 910 of the computing device 900, and the one or more memory devices may correspond to the memory 930 of the computing device 900. The program code or instruction may be executed by one or more processors to manage electric vehicle charging by providing charger information for a plurality of chargers in the charging station to a charging person and a charging waiting person.

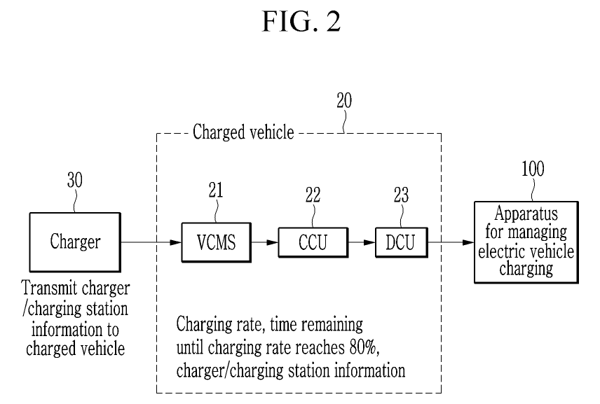

FIG. 2 is a block diagram illustrating the system of FIG. 1 in detail according to the embodiment of the present disclosure.

The apparatus 100 for managing electric vehicle charging within the charging station may include an integrated management server of the charged vehicle 20. Alternatively, the apparatus 100 for managing electric vehicle charging within the charging station may be one module included in the integrated management server of the charged vehicle 20.

The integrated management server of the charged vehicle 20 receives and stores various information related to the operation and control of the vehicle from the charged vehicle 20.

That is, the apparatus 100 for managing electric vehicle charging in the charging station may receive and store all information related to charging together with vehicle-related driving information, sensor information, and vehicle information from the charged vehicle 20.

Referring to FIG. 2, the charger 30 provides information related to the charger and the charging station to the apparatus 100 for managing electric vehicle charging in the charging station through a VCMS (Vehicle Charging Management System) 21, a CCU (Central Communication Unit) 22, and a DCU (Domain Control Unit) 23 of the charged vehicle 20.

The charger 30 provides the charger information and the charging state information of the charged vehicle to the VCMS 21 of the charged vehicle. The charging state information may include a current charging rate, a time remaining until the charging rate reaches 80%, whether charging is completed, and the like.

That is, the apparatus 100 for managing electric vehicle charging in the charging station may receive various information related to the charging state of the charger and the charged vehicle from the charged vehicle 20 while the starting of the charged vehicle is turned off.

Even if the starting of the charged vehicle 20 is turned off, the VCMS 21 (a charging controller) is revived through the Ig3 power source during charging, and the CCU 22 (a CCU controller) is always connected through the B+ power source.

Even when the CCU 22 is a sleep mode, the CCU is woken up while the charged vehicle 2 is being charged.

For example, the CCU may be woken up through a charging port door signal of a charged vehicle, or may be woken up by detecting communication with the VCMS.

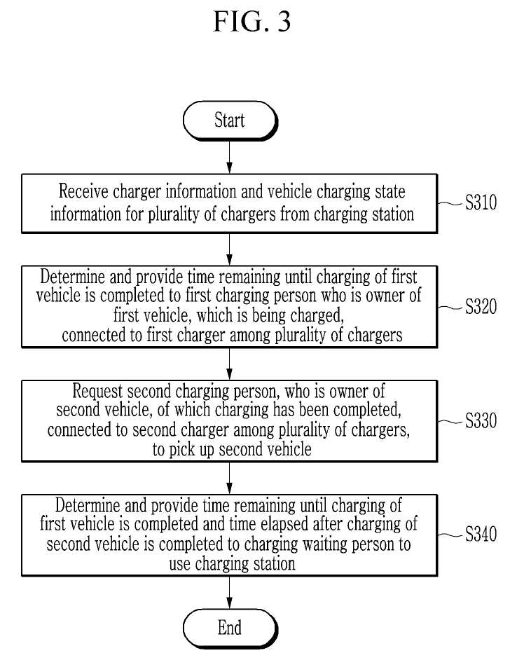

FIG. 3 is a flowchart of a method of managing electric vehicle charging in a charging station according to an embodiment of the present disclosure. The method of managing electric vehicle charging in the charging station of FIG. 3 may be performed by the apparatus 100 for managing electric vehicle charging in the charging station of FIG. 1.

In FIG. 3, the apparatus 100 for managing electric vehicle charging in the charging station may receive charger information and vehicle charging state information for a plurality of chargers from the charging station (S310).

The apparatus 100 for managing electric vehicle charging in the charging station may directly receive charger information and vehicle charging state information for a plurality of chargers through the charger management server from a plurality of chargers.

The apparatus 100 for managing electric vehicle charging in the charging station may receive charger information and vehicle charging state information from a vehicle connected to the charger.

The apparatus 100 for managing electric vehicle charging in the charging station may determine and provide a time remaining until the charging of a first vehicle is completed to a first charging person who is the owner of the first vehicle, which is being charged, connected to a first charger among the plurality of chargers (S320).

The apparatus 100 for managing electric vehicle charging in the charging station may request a second charging person, who is the owner of a second vehicle, of which charging has been completed, connected to a second charger among the plurality of chargers, to pick up the second vehicle (S330).

The apparatus 100 for managing electric vehicle charging in the charging station may determine and provide a time remaining until the charging of the first vehicle is completed and a time elapsed after the charging of the second vehicle is completed to a charging waiting person to use the charging station (S340).

The apparatus 100 for managing electric vehicle charging in the charging station may determine the shortest distance between the first vehicle and the first charging person based on the GPS of the charging person terminal of the first charging person.

The apparatus 100 for managing electric vehicle charging in the charging station may provide an alarm to the first charging person when the shortest distance exceeds a preset reference distance.

The apparatus 100 for managing electric vehicle charging in the charging station may determine the walking time to the first vehicle of the first charging person based on the shortest distance.

The apparatus 100 for managing electric vehicle charging in the charging station may provide an alarm to the first charging person when a time remaining until charging is completed is less than the walking time.

The apparatus 100 for managing electric vehicle charging in the charging station may provide an interface for requesting the second charging person to pick up the second vehicle to the charging waiting person terminal of the charging waiting person when the time elapsed after the completion of the charging of the second vehicle for which the charging has been completed exceeds a preset reference time.

When the second vehicle is disconnected from the second charger after the pickup request for the second vehicle is received through the interface of the charging waiting person terminal, the apparatus 100 for managing electric vehicle charging in the charging station may provide a notification of disconnection of the second vehicle to the charging waiting person.

The apparatus 100 for managing electric vehicle charging in the charging station may provide a reward to the second charging person through the charging person terminal when the second charging person receives a request for pickup of the second vehicle and picks up the second vehicle within a predetermined time.

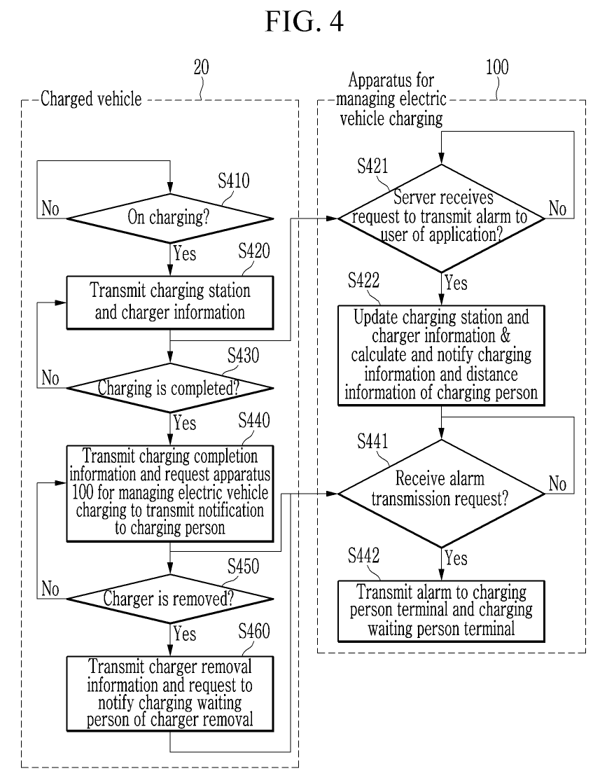

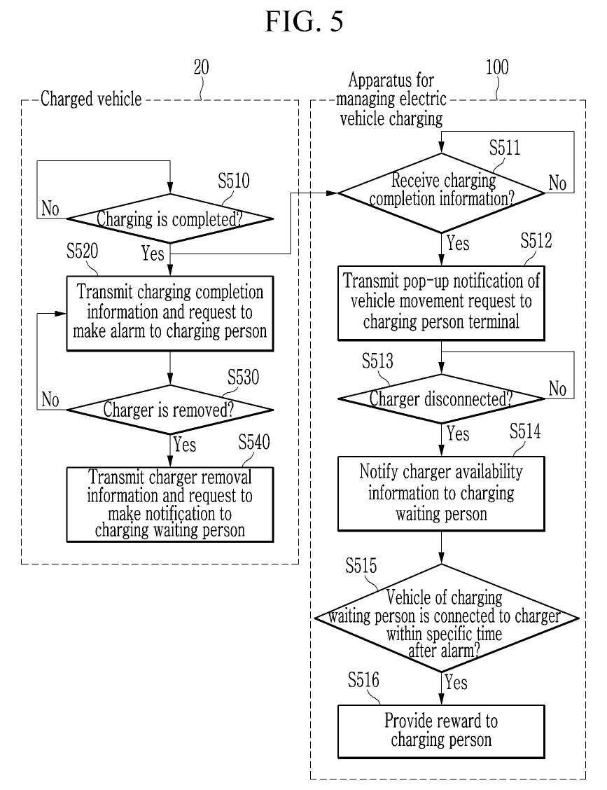

FIGS. 4 and 5 are flowcharts of the method of managing electric vehicle charging in the charging station according to the embodiment of the present disclosure. The method of managing electric vehicle charging in the charging station may be performed by the apparatus 100 for managing electric vehicle charging in the charging station of FIG. 1.

FIG. 4 is a flowchart illustrating a process in which the apparatus 100 for managing electric vehicle charging (hereinafter, referred to as an electric vehicle charging management apparatus) in the charging station delivers charger-related information and provides notification to a charging person and a charging waiting person.

In FIG. 4, the charged vehicle 20 detects connection to the charger (S410).

When the charged vehicle 20 is connected to the charger and is being charged, the charged vehicle 20 may receive the charger information and the charging station information from the connected charger and transmit the received information in real time to the electric vehicle charging management apparatus (S420).

The charged vehicle 20 may also transmit vehicle charging state information to the electric vehicle charging management apparatus in real time (S420).

The charged vehicle 20 determines whether the ongoing charging is completed (S430).

When the charging is completed, the charged vehicle 20 transmits the charging completion information to the apparatus 100 for managing electric vehicle charging and requests the apparatus 100 for managing electric vehicle charging to transmit a notification to the charging person (S440).

The charged vehicle 20 detects whether the charger is removed from the vehicle through a sensor (S450).

When the removal of the charger is confirmed, the charged vehicle 20 transmits charger removal information and a request to notify the charging waiting person of the charger removal to the apparatus 100 for managing electric vehicle charging (S460).

The apparatus 100 for managing electric vehicle charging detects reception of the charger information and the charging station information from the charged vehicle 20 (S421).

When the charger information and the charging station information are received, the apparatus 100 for managing electric vehicle charging updates the charger information and the charging station information in real time.

The apparatus 100 for managing electric vehicle charging may recognize the charging state information of the vehicle of the charging person through the charger information and transmit an alarm to the charging person according to the distance from the charged vehicle of the charging person and the charging progress of the charged vehicle (S422).

For example, the apparatus 100 for managing electric vehicle charging may calculate a time until a charging state is reached to 80% before a charging is completed. The apparatus 100 for managing electric vehicle charging may calculate a distance to a current charged vehicle of the charging person and a walking time of the corresponding distance by using GPS information of the charging person terminal.

When the walking time from the current location of the charging person to the charged vehicle exceeds the time to reach the 80% charging state of the charged vehicle, the apparatus 100 for managing electric vehicle charging may transmit a notification of the corresponding content to the charging person terminal.

The apparatus 100 for managing electric vehicle charging may detect reception of an alarm request for completion information of the charged vehicle and charger removal information from the charged vehicle (S441).

When the request to make an alarm to the charging person for the charging completion information is received, the apparatus 100 for managing electric vehicle charging provides the alarm that the charging has been completed to the charging person terminal (S442).

The apparatus 100 for managing electric vehicle charging notifies the charging waiting person terminal that the waiting charger has been removed from the charged vehicle as an alarm when a request for making an alarm to the charging waiting person for the charger removal information is received (S442).

FIG. 5 is a flowchart illustrating a method in which the apparatus 100 for managing electric vehicle charging in the charging station increases the rotation rate of the charger by paying a reward to the charging person.

In FIG. 5, when the charging completion is detected (S510), the charged vehicle 20 transmits the charging completion information to the apparatus 100 for managing electric vehicle charging together with a request for making a notification to the charging person (S520).

When charging is completed and the charger removal is detected by the charging person (S530), the charged vehicle 20 transmits an alarm for a charging waiting person together with the charger removal information to the apparatus 100 for managing electric vehicle charging (S540).

When the charging completion information is received from the charged vehicle 20 (S511), the apparatus 100 for managing electric vehicle charging may transmit a pop-up notification of a vehicle movement request to the charging person terminal (S512).

When the apparatus 100 for managing electric vehicle charging receives a request for transmitting charging completion information to the charging person terminal for the charged vehicle from the charging waiting person terminal after a certain period of time has elapsed after receiving the charging completion information, the apparatus 100 for managing electric vehicle charging may immediately provide the charging completion information and a pop-up notification of the vehicle movement request to the charging person terminal.

When a charger disconnection is detected (S513), the apparatus 100 for managing electric vehicle charging may provide an alarm of the charger removal information and charger availability information to the charging waiting person (S514).

The apparatus 100 for managing electric vehicle charging may determine whether the corresponding charger is removed within a specific time after transmitting the notification of the vehicle movement request to the charging person terminal, and whether the vehicle of the charging waiting person is connected to the charger (S515).

When it is confirmed that the charged vehicle is disconnected within the specific time after the alarm, and the connection of the vehicle of the charging waiting person is normal, the apparatus 100 for managing electric vehicle charging may provide a reward to the charging person through an application of the charging person terminal (S516).

The apparatus 100 for managing electric vehicle charging may provide a reward to the charging person by checking whether the charged vehicle of the charging person has been removed from the charger within the specific time after notifying the vehicle movement request and whether the vehicle of the charging waiting person is normally connected to the charger afterward.

The reward is not limited to a specific form and may include cryptocurrency, coins, or coupons as a payment means or discount means that may be used inside or outside the application.

The apparatus 100 for managing electric vehicle charging may determine whether to pay a reward to the charging person by determining whether the vehicle of the charging waiting person is connected to the charger within a specific time after the alarm requesting movement of the charged vehicle of the charging person is transmitted.

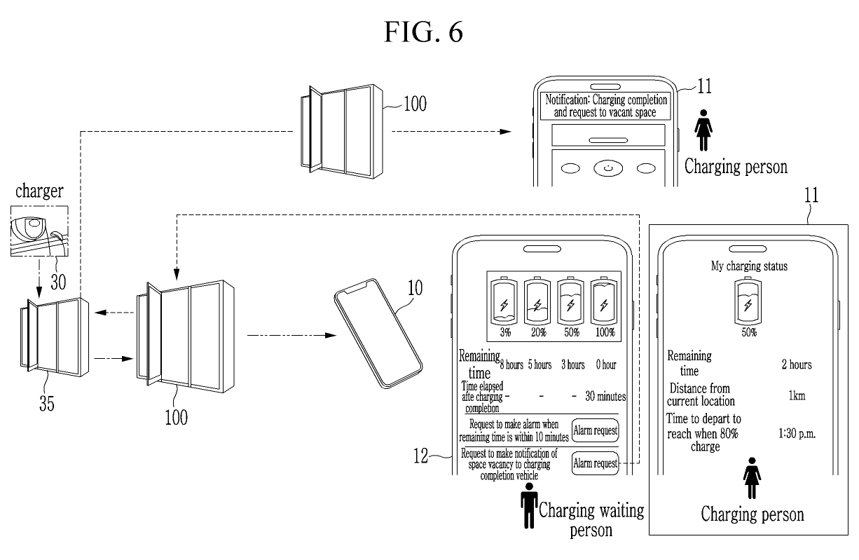

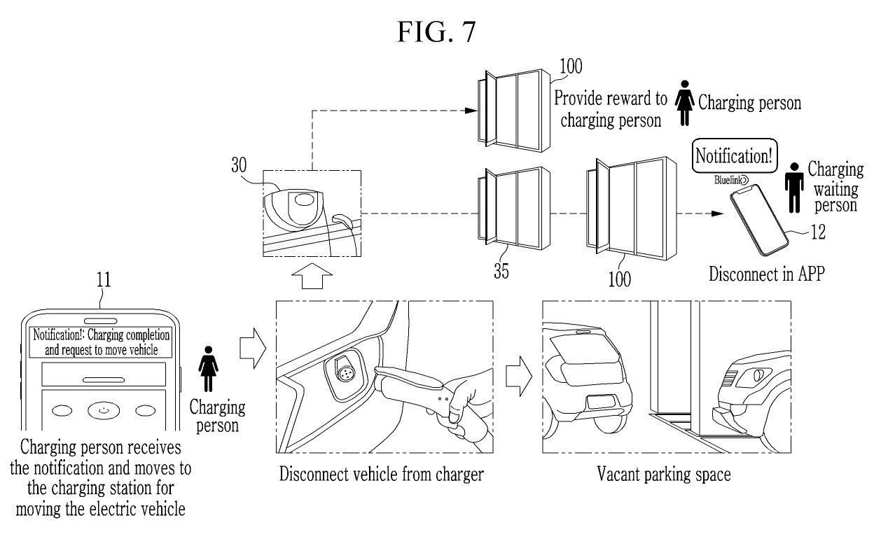

FIGS. 6 and 7 are diagrams illustrating a scenario according to the method for managing electric vehicle charging in the charging station according to the embodiment of the present disclosure.

In FIG. 6, the apparatus 100 for managing electric vehicle charging receives charger information for the charger 30 and charging state information for the vehicle connected to the charger 30 through the charger management server 35.

The apparatus 100 for managing electric vehicle charging displays the received charger information and charging state information of the charged vehicle on the user terminal 10 through an application and provides an interface to the user.

That is, the apparatus 100 for managing electric vehicle charging allows a user to check information on the time remaining until the charging of each charger of the charging station provided through the application and the time elapsed after the charging is completed.

The apparatus 100 for managing electric vehicle charging may provide an interface to a user to receive or transmit various notifications for a charger and a charged vehicle for a charging reservation of the charger.

That is, the charging waiting person may check the time remaining until the charging of the chargers in which the charged vehicle is charging and the time elapsed after the completion of charging of the completed charger through the charging waiting person terminal 12.

The charging waiting person may request a charging waiting and charging completion alarm for the next use with respect the charger, which is being charged, through the interface of the charging waiting person terminal 12.

In addition, the charging waiting person may transmit an alarm requesting movement of a charged vehicle that has not been moved after charging is completed through the interface of the charging waiting person terminal 12.

When the apparatus 100 for managing electric vehicle charging receives a notification of a request for movement or a request for vacating a space of a vehicle that has been charged from the charging waiting person terminal 12, the apparatus 100 for managing electric vehicle charging transmits the notification to the charger 30 to which the charged vehicle is connected through the charger management server 35.

Therefore, the apparatus 100 for managing electric vehicle charging may ultimately provide the corresponding notification to the charging person terminal 11.

The charging person may check information on the time remaining until charging is completed, the time elapsed after charging is completed, and the movement distance and moving time from the current location of the charging person to the charger through the charging person terminal 11, together with the charging status of the charged vehicle.

In FIG. 7, the apparatus 100 for managing electric vehicle charging may transmit a charging completion notification and a vehicle movement request to the charging person terminal 11.

When the charging person moves to the charging station to pick up the charged vehicle, removes the charger, and vacates the parking space, the charging person may provide the corresponding information (such as charger removal information) to the apparatus 100 for managing electric vehicle charging through the charger management server 35.

The apparatus 100 for managing electric vehicle charging provides a notification including the charger removal information to the charging waiting person terminal 12.

When the vehicle of the charging waiting person is connected to the charger, the apparatus 100 for managing electric vehicle charging provides a reward to the charging person terminal 11 under certain conditions.

FIG. 8 is a diagram illustrating a computing device according to an embodiment of the present disclosure.

Referring now to FIG. 8, the apparatus and method of managing electric vehicle charging in the charging station according to the embodiments may be implemented by using a computing device 900.

The computing device 900 may include at least one of a processor 910, a memory 930, a user interface input device 940, a user interface output device 950, and a storage device 560 communicating via a bus 920. The computing device 900 may also include a network interface 970 that is electrically connected to a network 90. The network interface 970 may transmit or receive a signal with another entity through the network 90.

The processor 910 may be implemented in various types, such as a Micro Controller Unit (MCU), an Application Processor (AP), a Central Processing Unit (CPU), a Graphic Processing Unit (GPU), a Neural Processing Unit (MPU), and the like, and may be a predetermined semiconductor device executing commands stored in the memory 930 or the storage device 960. The processor 910 may be configured to implement the functions and the methods described above with reference to FIGS. 1 to 7.

The memory 930 and the storage device 960 may include various forms of volatile or non-volatile storage media. For example, the memory may include a Read Only Memory (ROM) 931 and a Random Access Memory (RAM) 932. In the embodiment, the memory 930 may be located inside or outside the processor 910, and the memory 930 may be connected with the processor 910 through already known various means.

In some embodiments, at least some configurations or functions of the apparatus and method of managing electric vehicle charging in the charging station according to the embodiments may be implemented as programs or software executed on the computing device 900, and the programs or software may be stored on a computer-readable medium.

In some embodiments, at least some configurations or features of the apparatus and method of managing electric vehicle charging in the charging station according to the exemplary embodiments may be implemented using hardware or circuit of the computing device 900, or may be implemented as separate hardware or circuit that may be electrically connected to computing device 900.

Although the above embodiments of the present disclosure have been described in detail, the scope of the present disclosure is not limited thereto, but also includes various modifications and improvements by one of ordinary skill in the art utilizing the basic concepts of the present disclosure as defined in the following claims.

1. A method of managing electric vehicle charging in a charging station, the method comprising:
receiving, from a charging station, charger information and vehicle charging status information for a plurality of chargers;
determining a time remaining until completion of charging of a first vehicle which is being charged and is connected to a first charger among the plurality of chargers;
providing the time remaining until completion of charging of the first vehicle to a first charging person via a charging person terminal;
requesting a second charging person having a second vehicle connected to a second charger to pick up the second vehicle when charging is complete;
determining a time elapsed after completion of the charging of the second vehicle; and
providing the time remaining until the completion of charging of the first vehicle to a charging waiting person waiting to use the charging station via a charging waiting person terminal.

2. The method of claim 1, wherein receiving the charger information and the vehicle charging status information includes directly receiving charger information and vehicle charging status information for the plurality of chargers from the plurality of chargers through a charger management server.

3. The method of claim 1, wherein receiving of the charger information and the vehicle charging status information includes receiving the charger information and the vehicle charging status information from a vehicle connected to the charger.

4. The method of claim 1, further comprising:
determining a shortest distance between the first vehicle and the first charging person based on a global positioning system (GPS) of the charging person terminal of the first charging person; and
providing an alarm to the first charging person when the shortest distance exceeds a preset reference distance.

5. The method of claim 4, further comprising:
determining a walking time of the first charging person to the first vehicle based on the shortest distance; and
providing an alarm to the first charging person when the time remaining until the completion of the charging is less than the walking time.

6. The method of claim 1, further comprising:
providing an interface for requesting the second charging person to pick up the second vehicle to the charging waiting person terminal when the time elapsed after the completion of charging of the second vehicle exceeds a preset reference time.

7. The method of claim 6, further comprising:
when the second vehicle is disconnected from the second charger after the request to pick up the second vehicle is received through the interface of the charging waiting person terminal, providing a notification to the charging waiting person that the second vehicle is disconnected.

8. The method of claim 7, further comprising:
when the second charging person receives a request for pickup of the second vehicle and picks up the second vehicle within a predetermined time, and when the charging waiting person uses the second charger, providing a reward to the second charging person through the charging person terminal.

9. The method of claim 1, wherein the first charging person is an owner of the first vehicle.

10. The method of claim 1, wherein the second charging person is an owner of the second vehicle.

11. An apparatus for managing electric vehicle charging comprising:
a memory storing computer-executable instructions; and
at least one processor configured to access the memory and execute the instructions, wherein the instructions comprise:
receiving charger information and vehicle charging status information for a plurality of chargers from a charging station;
determining a time remaining until completion of charging of a first vehicle to a first charging person;
providing the time remaining until completion of charging of a first vehicle to a first charging person via a charging person terminal;
requesting a second charging person having a second vehicle connected to a second charger to pick up the second vehicle when charging is complete;
determining a time elapsed after the completion of the charging of the second vehicle; and
providing the time remaining until the completion of charging of the first vehicle to a charging waiting person waiting to use the charging station via a charging waiting person terminal.

12. The apparatus of claim 11, wherein receiving the charger information and the vehicle charging status information includes directly receiving charger information and vehicle charging status information for the plurality of chargers from the plurality of chargers through a charger management server.

13. The apparatus of claim 11, wherein receiving the charger information and the vehicle charging status information includes receiving the charger information and the vehicle charging status information from a vehicle connected to the charger.

14. The apparatus of claim 11, wherein the instructions further comprise:
determining a shortest distance between the first vehicle and the first charging person based on a global positioning system (GPS) of the charging person terminal of the first charging person; and
providing an alarm to the first charging person when the shortest distance exceeds a preset reference distance.

15. The apparatus of claim 14, wherein the instructions further comprise:
determining a walking time of the first charging person to the first vehicle based on the shortest distance; and
providing an alarm to the first charging person when the time remaining until the completion of the charging is less than the walking time.

16. The apparatus of claim 11, wherein the instructions further comprise:
providing an interface for requesting the second charging person to pick up the second vehicle to the charging waiting person terminal when the time elapsed after the completion of charging of the second vehicle exceeds a preset reference time.

17. The apparatus of claim 16, wherein the instructions further comprise:
when the second vehicle is disconnected from the second charger after the request to pick up the second vehicle is received through the interface of the charging waiting person terminal, providing a notification to the charging waiting person that the second vehicle is disconnected.

18. The apparatus of claim 17, wherein the instructions further comprise:
when the second charging person receives a request for pickup of the second vehicle and picks up the second vehicle within a predetermined time, and when the charging waiting person uses the second charger, providing a reward to the second charging person through the charging person terminal.

19. The apparatus of claim 13, wherein the first charging person is an owner of the first vehicle.

20. The apparatus of claim 13, wherein the second charging person is an owner of the second vehicle.
